(19) United States
(12) Patent Application Publication
(10) Pub. No.: US 2007/0139870 A1
(43) Pub. Date: Jun. 21, 2007

(54) Monitor display carrier

(76) Inventor: Christina Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/305,261

(22) Filed: Dec. 19, 2005

(51) Int. Cl. G06F 1/16

(52) U.S. Cl. 361/681; 248/917

(57) ABSTRACT

A monitor display carrier includes a top base, a bottom mount coupled to the top base, a casing constituted by upper and lower casing members interposed between the top base and the bottom mount, and a USB module encased in the casing. An adjustable arm extends from the top base and supports a monitor display in an orientation- and position-adjustable manner. The bottom mount has a clamp that releasably attaches the carrier to a fixture. The USB module is arranged in the interior space between the upper and lower casing members, which form a unitary device completely covering the USB module with USB sockets of the module exposed to selectively engage corresponding USB ends of connection cables of peripheral devices to provided improved cable organization and easy connection/disconnection of the peripheral devices.

### BACKGROUND OF THE INVENTION

1. Field of the Invention

The present invention generally relates to an adjustable computer monitor carrier, and in particular to a computer monitor display carrier forming a plurality of USB sockets to releasably connect cables of USB based computer peripheral devices for improved organization of the cables and easy connection/disconnection of the peripheral devices.

2. The Related Art

Computer facility, especially a personal computer, is often installed on the top of a computer desk. Conventionally, the computer desk is designed to accommodate and/or allow for movement of computer peripheral devices, such as a computer monitor, a keyboard, a computer mouse, and a printer. All the peripheral devices are arranged in a very limited space, which is advantageous for saving footprint occupied by the peripheral devices.

A further improvement of the computer desk or computer support device utilizes a number of brackets or carriers to support individual peripheral devices. This saves further space. However, since most of the peripheral devices are wired to the computer by cables, both designs of the above-discussed known computer desks do not provide good organization of the cables. This makes the computer facility a big mass of wires and cables. Further, connection and disconnection of the peripheral devices are complicated due to the mass of cables. The external appearance of the computer facility is also poor.

### SUMMARY OF THE INVENTION

Thus, the present invention is aimed to provide a computer monitor carrier that overcomes or at least alleviates the drawbacks of the conventional devices.

An objective of the present invention is to provide a computer monitor carrier, which comprises a USB module having USB sockets to matingly engage USB connectors of peripheral devices in order to organize USB cables by which the USB peripheral devices connect to a host device of a computer system and also simplify connection/disconnection of the peripheral devices to/from the computer system.

To achieve the above objective, in accordance with the present invention, a monitor display carrier comprises a top base, a bottom mount, a casing comprised of upper and lower casing members interposed between the top base and the bottom mount, and a USB module encased in the casing. The top base has topside from which an adjustable arm extends. The adjustable arm has a free end forming a connection member to which a monitor display is releasably attached. The adjustable arm allow for adjustment of the orientation and position of the monitor display attached to the connection end thereof. The bottom mount is coupled to an underside of the top base and comprises a clamp movably attached to an underside thereof for releasably fixing the monitor carrier to a fixture and thus supporting the monitor on the fixture. The USB module is arranged in an internal space defined between the upper and lower casing members and comprises a plurality of USB sockets arranged between the upper and lower casing members to each releasably connect a USB device. The upper and lower casing members are fixed between the top base and the bottom mount as a unitary device that completely covers the USB module.

From an external appearance of the monitor display carrier of the present invention, the carrier as a whole can be releasably mounted to an external fixture by the clamps. The casing that is interposed between the top base and the bottom mount completely covers or houses the USB module, which shows a plurality of USB sockets in a side face of the casing. The monitor display is mounted to the top base in a position- and orientation-adjustable manner. Based on the above-discussed construction, cables of peripheral devices to be connected to a computer system can be well organized by having individual cable-end USB connector plugged into the USB sockets. This not only provides an improved organization of the cables of peripheral devices, but also allows easy connection/disconnection of the peripheral devices to/from the computer system with simple plugging operation.

The carrier can be manufactured in different ways. For example, the carrier can be made as a stand-alone device that is positioned directly on the floor to function as a standing support for a computer monitor or other displays. Or alternatively, a number of the carriers can be combined as a large frame to each support one monitor display so that a plurality of monitors can be mounted on the same frame.

Also, if desired, a number of USB modules can be arranged in the casing to effect organization of cables of different peripheral devices for carriers of different designs. Further, USB sockets that constitute the USB modules can be partly or all replaced by USB plugs that connect with USB sockets of peripheral devices.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of monitor display carrier constructed in accordance with the present invention;

FIG. 2 is similar to FIG. 1, but with a monitor display attached to an adjustable arm of the monitor display carrier of the present invention;

FIG. 3 is an exploded view of the monitor display carrier of the present invention, together with the monitor display attached to the adjustable arm; and

FIG. 4 is a perspective view showing a practical application of the monitor display carrier of the present invention, which is attached to an operation platform for a computer system.

### DETAILED DESCRIPTION OF THE PREFERRED EMBODIMENT

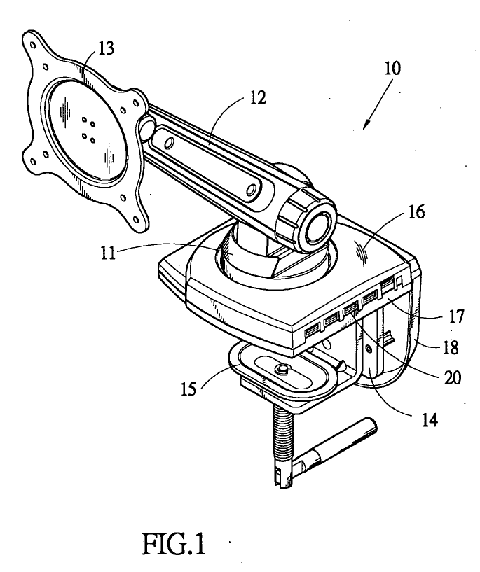

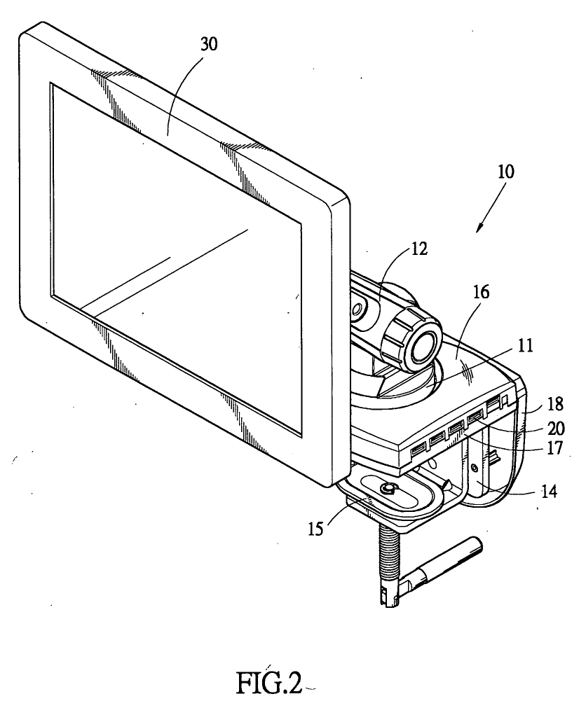

With reference to the drawings and in particular to FIGS. 1, 2, and 3, which show, respectively, a perspective view of a monitor display carrier constructed in accordance with the present invention, a perspective view of the monitor display carrier with a monitor display mounted thereto, and an exploded view of the monitor display carrier, the monitor display carrier in accordance with the present invention, generally designated with reference numeral 10 throughout all the drawings, comprises a top base 11 having an underside to which a bottom mount 14 is coupled, a casing constituted by mated upper and lower casing members 16, 17 interposed between the top base 11 and the bottom mount 14, and a USB (Universal Serial Bus) module 19 encased in the casing by being positioned in an interior space defined between the upper and lower casing members 16, 17.

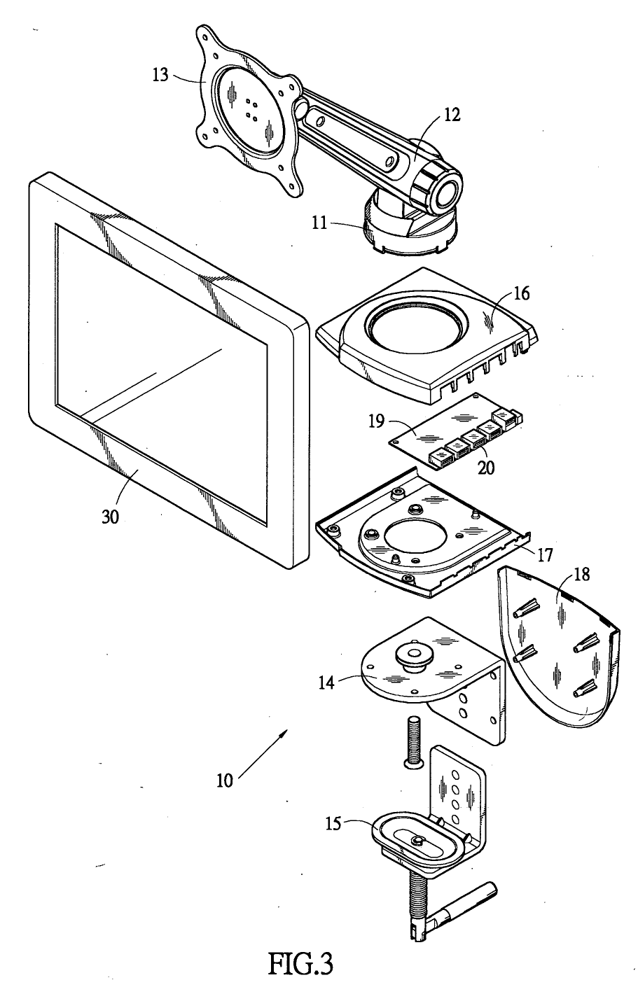

As shown in FIGS. 1 and 3, the top base 11 comprises an adjustable arm 12 mounted to a top of the base 11 and having a free end forming a connection member 13 to which a monitor display 30, preferably a flat display, is releasably attached. The adjustable arm 12 is movable for adjustment of orientation and position of the monitor 30 attached to the connection end 13.

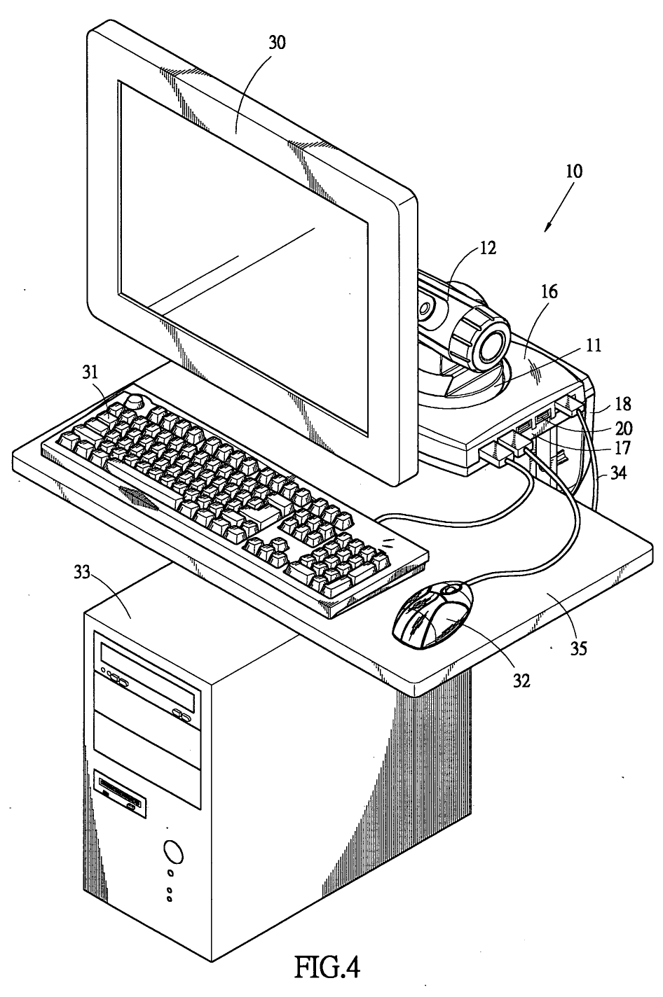

Still referring to FIG. 3, the bottom mount 14 comprises a bottom clamp 15 movably coupled to an underside of the mount 14. The movement of the clamp 15 toward/away from the mount 14 effects clamping and releasing of for example an operation platform 35, which can be for example a top of a computer desk, between the mount 14 and the clamp 15, thereby releasably securing the carrier 10 to the operation platform 35, as illustrated in FIG. 4. The carrier 10 and the monitor display 30 attached thereto are thus releasably attached to the operation platform 35.

As shown in FIG. 3, the USB module 19, which is arranged in the interior space between the upper and lower casing members 16, 17, forms receptacle openings 20 in a face of the casing, preferably along an interface between the upper and lower casing members 16, 17. Each opening 20 defines a USB socket that constitutes in part the USB module 19 for selective connection with a USB device (not shown).

Preferably, the casing members 16, 17 are fixed between the top base 11 and the bottom mount 14 as a unitary device, which completely encloses the USB module 19.

Also referring to FIG. 4, in practical use, the carrier 10 is releasably attached to the operation platform 35, or a desktop, by the clamp 15 that clamps on the operation platform 35. The casing constituted by mating upper and lower casing members 16, 17 together and fixed in position by being interposed between the top base 11 and the bottom mount 14 provides a number of USB sockets 20 that are formed in one side face of the casing and constituting the USB module 19 encased in the casing. The adjustable arm 12 of the carrier 10 allows a user to adjust the location and orientation of the display 30 attached to the connection end 13 of the arm 12. Thus, peripheral devices, such as a keyboard 31 and a computer mouse 32 can be connected to the USB module 19 through plugging into the USB sockets 20. The USB module 19 can be directly wired to a USB port (not shown) of a computer 33. Or alternatively, the USB module 19 functions as a USB hub that is connected to the computer 33 through a USB cable 34 that is plugged in one of the USB sockets 20 of the module 19. The provision of the USB module 19 allows well organization of the wires of other peripheral devices and easy connection/disconnection of the peripheral devices.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A monitor display carrier, comprising:
a top base from which an adjustable arm extends, adapted to movably support a monitor display;
a bottom mount coupled to an underside of the base and comprising a clamp movably attached to an underside thereof adapted to releasably fix the carrier to a fixture to thereby support the monitor display on the fixture;
an extended connection device fixed between the top base and the bottom mount, comprising a USB module comprising at least one USB socket adapted to releasably connect a USB device.

2. The monitor display carrier as claimed in claim 1, wherein the extended connection device comprises a casing that encloses the USB module and forms an opening in a face thereof to expose each USB socket.

3. The monitor display carrier as claimed in claim 2, wherein the casing comprises an upper casing member and a lower casing member mated to each other to enclose the USB module therein, the upper and lower casing members being fixed between the top base and the bottom mount.

4. The monitor display carrier as claimed in claim 1, wherein the adjustable arm has a free end forming a connection member to which the monitor display is releasably attached.
